(19) United States
(12) Patent Application Publication
(10) Pub. No.: US 2018/0163698 A1
(43) Pub. Date: Jun. 14, 2018

(54) PNEUMATIC ACCESSORY TO LIMIT AERODYNAMIC FORCES IN HORIZONTAL AXIS WIND TURBINE BLADES

(71) Applicant: Centro de Ingeniería y Desarrollo Industrial, QUERÉTARO (MX)

(72) Inventors: Paniagua Edgar MIRANDA, QUERÉTARO (MX); Hernández Guillermo MUÑOZ, CORREGIDORA (MX); López José Luis GONZÁLEZ, QUERÉTARO (MX); Trejo Miguel Angel LARA, MINERAL DE LA REFORMA (MX); Ledesma Saul LEDESMA, QUERÉTARO (MX)

(21) Appl. No.: 15/839,793

(22) Filed: Dec. 12, 2017

(30) Foreign Application Priority Data
Dec. 13, 2016 (MX) MX/A/2016/016942

(51) Int. Cl. F03D 7/02; F03D 1/06; F03D 7/04

(52) U.S. Cl. CPC F03D 7/0232; F03D 7/04; F03D 1/0633

(57) ABSTRACT

This invention consists of a pneumatic accessory to limit aerodynamic forces in horizontal axis wind turbine blades, which is mainly integrated by an inflatable seal or microtab, a rigid cover with a specific shape that assembles onto a cavity external to the suction surface of the blade, and a pneumatic feed system.

### CROSS-REFERENCE TO RELATED APPLICATIONS

This application claims priority from Mexico Application Serial No. MX/a/2016/016942 filed on Dec. 13, 2016, which is incorporated herein by reference in its entirety.

### STATEMENT REGARDING FEDERALLY SPONSORED RESEARCH OR DEVELOPMENT

This invention was made in part with Mexico Government support under Mexican Government CEMIE-Eolic Consortium of Energy Sustainability Fund, project number P03, grant number 000000000206842. The Mexican Government may have certain rights in the invention.

### FIELD

The present invention consists of an accessory to improve wind turbine and aero generator blade performance and to increase related power production.

### INTRODUCTION

Worldwide energy production using wind turbines has shown important growth in comparison with, and in combination with, other renewable resources. other renewable resources, such as photovoltaic energy sources, have achieved competitive costing and have even improved the supply, in some cases, of wind systems. However, cost reduction in the production of wind energy is a current challenge for wind turbines. Therefore, the trend to increase the size of wind turbines to reduce costs is a palpable trend over time. At present, wind turbines are designed on the order of 8 MW and 164 meters in diameter, or blades in the order of 80 meters in length, for which the aerodynamic loads in components are starting to be a true technology challenge regarding the materials used in designing and creating the blades.

An approach that has been thoroughly studied in the world in the last several decades is the use of devices to limit the aerodynamic forces developed on wind turbine blades while in operation. Such devices are passive or active, and given their automatic response they have come to be named “smart blades.” Passive methods include no actuators in their designs and can be briefly described as flexible blades, having an orientation system and aero elastic adjustment system related to the blades. Within the active methods, there are various devices, some arising from aeronautical applications such as flaps, vortex generators, profiles with shape change, plasma actuators, and microtabs.

Microtabs, or flow control micro walls, limit the flow of air to a certain height of the boundary layer of the aerodynamic profile and at a location close to the trailing edge of the aerodynamic profile. These devices offer attractive features because they are relatively small in size, are low in energy consumption and significantly limit aerodynamic forces without a relevant change to the drag force.

The state of the art related to this technology relates to devices limiting aerodynamic forces, among which the following can be listed:

U.S. Pat. No. 7,028,954 describes a microtab mechanism to be implemented by using translational micro-electro-mechanical elements (MEM). MEM's arrangement is a controlled distortion for deployment and shrinkage of the microtab. The preferred position to locate the microtabs is described as 5% of the cord, on the side of the trailing edge of profile and at a height of 1% of profile. The microtab shape is described as a rectangular prism that hides or comes out to the exterior surface of the blade.

U.S. Pat. No. 8,192,161 and U.S. Pat. No. 8,267,654 describe a number of microtabs, arranged in various radial positions of the blade for various purposes, among them, the limitation of loads. The microtab deployment mechanism is located inside the blade, where it may include various drives to extend and shrink the microtab. Microtab deployment is made by any drive, which may be of pneumatic, hydraulic, or even electrical type. In case of a pneumatic system it may include directional valves and a controller. The blade includes grooves and reinforcing elements over the blade, to enable microtab deployment by the actuator.

US Pub. No. 2014/0271192 discloses twelve different types of actuators for microtabs, all inside the blade. The actuator housing assembly is also described by US Pub. No. 2014/0271191. The actuator can be assembled onto the blade in a modular way, through a reinforcing cover over the blade and bolted joints. The blade includes sufficient openings to disassemble the actuator and perform any part replacement or component maintenance.

U.S. Pat. No. 8,827,644 describes the use of microtabs in the blade, within a distance of 10% of the length of the cord from the trailing edge, but it does not describe a shape, type of actuator, or its implementation. Similarly, U.S. Pat. No. 9,341,160 describes a blade with adjustable means, which consists of distributed actuators, flaps, or microtabs to adjust an aerodynamic parameter.

Therefore, what is needed is an assembly comprising a microtab and having a specific shape which increases the efficiency and concomitant increase in energy production of wind turbines and aero generators.

### SUMMARY

This invention consists of a pneumatic accessory to limit aerodynamic forces in the horizontal axis of wind turbine blades, which is integrated by an inflatable seal or microtab, a rigid cover with the shape of the blade surface in its underside, and a pneumatic feed system. Those of skill in the art will recognize that improvements in wind turbine blades can also have applicability in aero generators and similar devices which use fluid-driven blades, and are sometimes used interchangeably in the present description. The present invention also relates to those devices.

The inflatable seal or microtab is of special design and manufacture for the size and shape of profile used in the air turbine blade. Activation of the pneumatic force limiting accessory on the horizontal axis of wind turbine blades is controlled by a pneumatic supply system consisting of pneumatic hoses, air inlets, rotary seals, a quick exhaust valve, an electro pneumatic valve, an air tank, and a progressive start unit.

The inflatable seal or microtab is placed inside a rigid cover in a specific way and the latter is in turn assembled on a cavity external to the suction surface of the blade. This prevents fiber cutting and possible grooves on the fibers of the composite material of the blade; the mechanical strength of the blade is not affected.

The cavity external to the suction surface of the blade is formed from the manufacture of the blade shells in composite material molds. The use of such a cavity external to the suction surface of the blade does not affect the aerodynamic shape of the blade, the manufacturing cost, or its mechanical resistance because no cuts are made in composite material fibers, but rather a cavity with continuity of fibers of the composite material. Similarly, pneumatic hoses and air inlets are placed inside the blade at the time of blade manufacture, by which a closed body is formed with no perforations or damage to the composite fibers of the blade, and with such minimum elements embedded inside the blade the internal intervention of the blade is minimized, as well as the risk of dirt entering and affecting in any way.

These and other features, aspects and advantages of the present teachings will become better understood with reference to the following description, examples and appended claims.

### DRAWINGS

Those of skill in the art will understand that the drawings, described below, are for illustrative purposes only. The drawings are not intended to limit the scope of the present teachings in any way.

FIG. 1. Perspective view of an air turbine and a pneumatic accessory to limit aerodynamic forces in the horizontal axis of wind turbine blades.

FIG. 2. Diagram of aerodynamic forces acting on an aerodynamic profile.

FIG. 3. Perspective view of an inflatable seal or microtab.

FIG. 4. Schematic of an inflatable seal or microtab at rest and extended.

FIG. 5. Perspective view of a rigid cover.

FIG. 6. Perspective view of a rigid cover showing the shape adapted to the blade.

FIG. 7. Assembly of an inflatable seal or microtab with a rigid cover.

FIG. 8. Cross section detail of a pneumatic accessory to limit aerodynamic forces in the horizontal axis of wind turbine blades.

FIG. 9.—Cross section detail of an air turbine blade and the fastening element with the accessory to limit aerodynamic forces in the horizontal axis of wind turbine blades.

FIG. 10. Cross section detail of an air turbine blade and its pneumatic connection to activate the pneumatic accessory to limit forces in the horizontal axis of wind turbine blades.

FIG. 11. Detail of a pneumatic connection of the pneumatic accessory to limit forces in the horizontal axis of wind turbine blades.

FIG. 12. Pneumatic diagram on the operation of the pneumatic accessory to limit forces in the horizontal axis of wind turbine blades.

FIG. 13. Demonstrative chart on the reduction and axial force.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g., ” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “internal,” “external,” “top,” “bottom,” “up,” “down,” and the like, are words of convenience and are not to be construed as limiting terms unless specifically stated to the contrary.

The present invention provides a pneumatic accessory to limit aerodynamic forces in the horizontal axis of wind turbine blades, which is integrated by an inflatable seal or microtab, a rigid cover with a specific shape that assembles onto a cavity external to the suction surface of the blade, and a pneumatic feed system.

Using the present invention, it is possible to limit the aerodynamic forces of specific blade designs, specifically the lift force and the axial force to which a blade is subjected during operation, which enables increasing the lifespan of turbine components due to a reduction in the magnitude of these forces during the wind turbine operation.

It also allows using longer blades that capture greater wind energy by using power generation components designed for a smaller rotor diameter.

Incorporating an inflatable seal or microtab in the pneumatic accessory for force limitation in the horizontal axis of wind turbine blades produces no variation of centrifugal forces, since its activation implies no significant mass movement. Furthermore, such an inflatable seal or microtab prevents dust, moisture, or dirt from entering the inside of the blade. It is worth emphasizing that maintenance is performed without internally manipulating the blade and disassembly is simple, which allows reduction of risks to the operators or maintenance personnel.

To increase the efficiency of energy generation by wind turbine technologies, as well as related profitability, new systems can be implemented to increase the lifespan of turbine components and increase the annual production of energy by reducing aerodynamic forces on wind turbine blades. There are many technology challenges to be solved.

A problem encountered in the art provides that the movement of blades in operation presents build-up of dirt associated to the interaction of the devices with insects, dust, and environmental humidity to limit related aerodynamic forces. Such build-up may eventually provoke clogging during operation of microtabs in the field. Moving parts such as microtabs involve contamination of the internal actuator by dirt and of the internal components of an actuator if grooves on the wind blades have no seals.

A second unresolved problem in the art relates to the need to make grooves on the composite material fibers of the blade, typically built of fiberglass composite material, which can generate a fracture initiation in the medium term. Alternatively, reinforcements are used around the groove, thus complicating material selection and the manufacturing process. The blade manufacturing process is not described in the state of the art, however it is a determining factor for the implementation of any accessory.

In addition, the reduced spaces within the blade imply the use of small volume actuators. Actuators in the art show the use of metal parts with moving mass, which causes centrifugal forces of varying magnitude. This variation of forces requires a manufacturer to considering this additional variable in the control system of a microtab in operation, and therefore provides a more complex system, including its hardware and software.

Maintenance of actuators described in the art represents a set of targets for the increased efficiency and power production capability of blades because actuators are located inside the blade, where it is difficult to access, and because blade manufacture requires forming a closed body with no perforations or damage to the composite material of the blade. In any case, accessing blade actuators implies cutting fibers and thus reducing the mechanical resistance or start of fracture, which implies a high risk to the reliable operation of the blade. Maintenance associated with the assembly and disassembly of actuators is complex, because maintenance must be performed at high elevations by maintenance technicians.

The specific positioning of a pneumatic force limiting adjuster on the horizontal axis of wind turbine blades not only solves the blade's mechanical strength issues, but also reduces the internal contamination of actuators described in the art, because the inflatable joint or microtab and the pneumatic supply are sealed at the time the blade is manufactured. An additional feature of this accessory is it is implemented in the conventional manufacture for air turbine blades.

Incorporating an inflatable seal or microtab produces no variation of centrifugal forces, given its activation does not imply any significant mass movement and includes no mechanical parts in friction that could be affected by dirt from insects, dust, or moisture. Furthermore, the inflatable seal or microtab is pressurized so as to prevent the entry of dust, moisture, or dirt in general. It is worth emphasizing that maintenance is performed without internally manipulating the blade, and disassembly is simple which provides a reduction of risk to blade and turbine maintenance staff.

In use, the invention makes it possible to limit the aerodynamic forces that blades are subject to during operation, which provides an increase in the lifespan of turbine components. It also allows using longer blades to capture greater wind energy, by using power generation components designed for smaller rotor diameters. Thus, using the present invention, the annual production of energy from turbines can increase, and the rotor diameter can increase, without changing the air turbine components for energy generation. A rotor diameter increase implies using longer blades to capture greater amount of kinetic energy from the same wind speed, i.e., the area for capturing energy from the wind is greater, which increases energy capture but using smaller forces than the those developed or manufactured without the accessory.

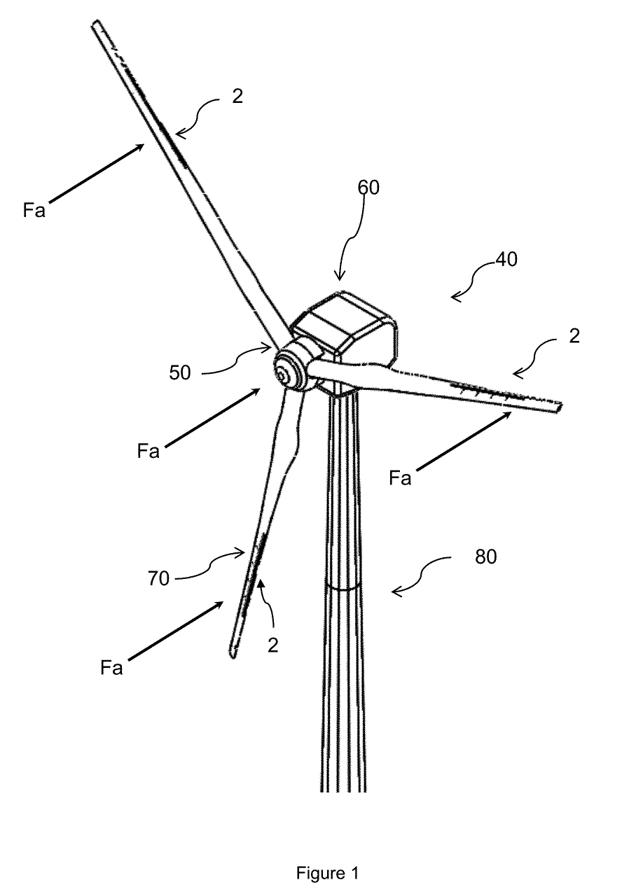

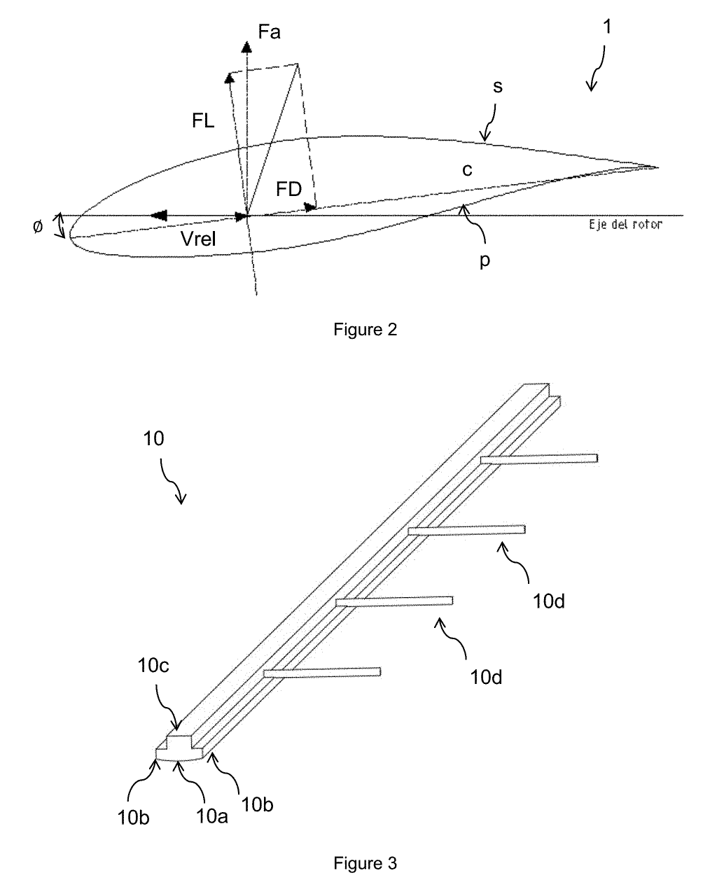

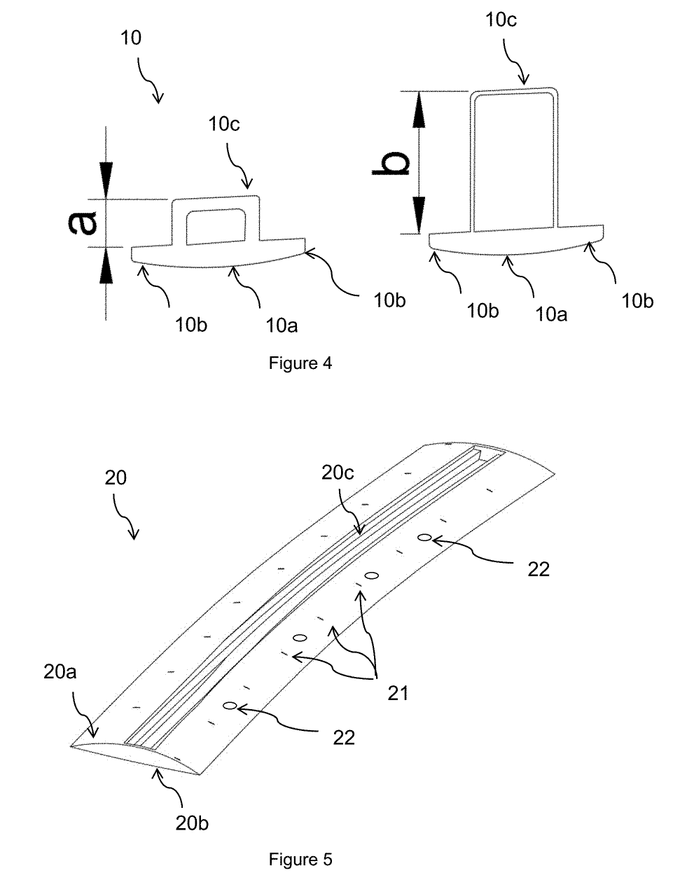

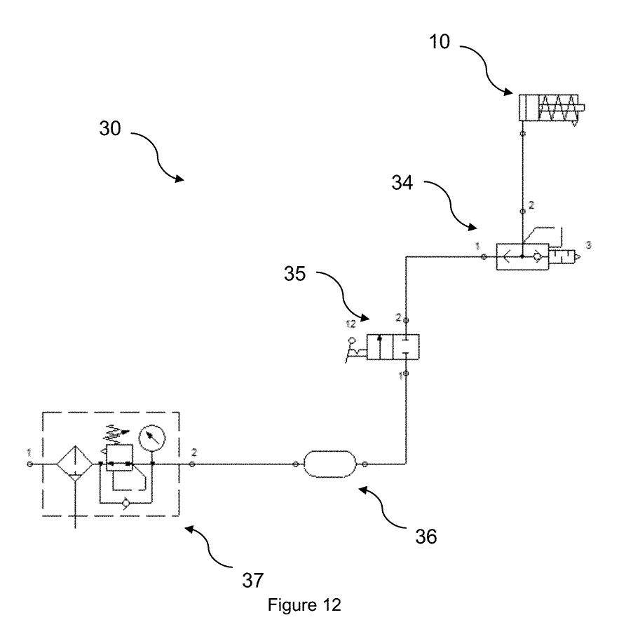

Referring generally to the figures, the assembly of the invention consists of a pneumatic accessory to limit aerodynamic forces in horizontal axis wind turbine blades (FIG. 1, item 2), it consists of an inflatable seal or microtab (FIGS. 2 and 4, item 10), a rigid cover (FIGS. 5-7, item 20) and a pneumatic feed system (FIG. 12, item 30); this accessory may be implemented in horizontal axis wind turbines (FIG. 1, item 40) and specifically in the blades (FIGS. 1, 8-11, item 70).

Referring to FIG. 1, horizontal axis wind turbines (40) are integrated by a rotor (50), a gondola (60) and a support or pole (80). The rotor (50) is typically integrated by three blades (70) of specific aerodynamic design. by which the rotor (50) moves a generator to convert the rotor's mechanical energy into electric power; this generator is located inside the gondola (60); the support or pole (80) provides stability and an elevated position to the rotor (50). Blades (70) incorporate the pneumatic accessory to limit aerodynamic forces on horizontal axis wind turbine blades (2), of this invention, at a certain distance along the blade (70), in order to enhance its use in limiting aerodynamic forces.

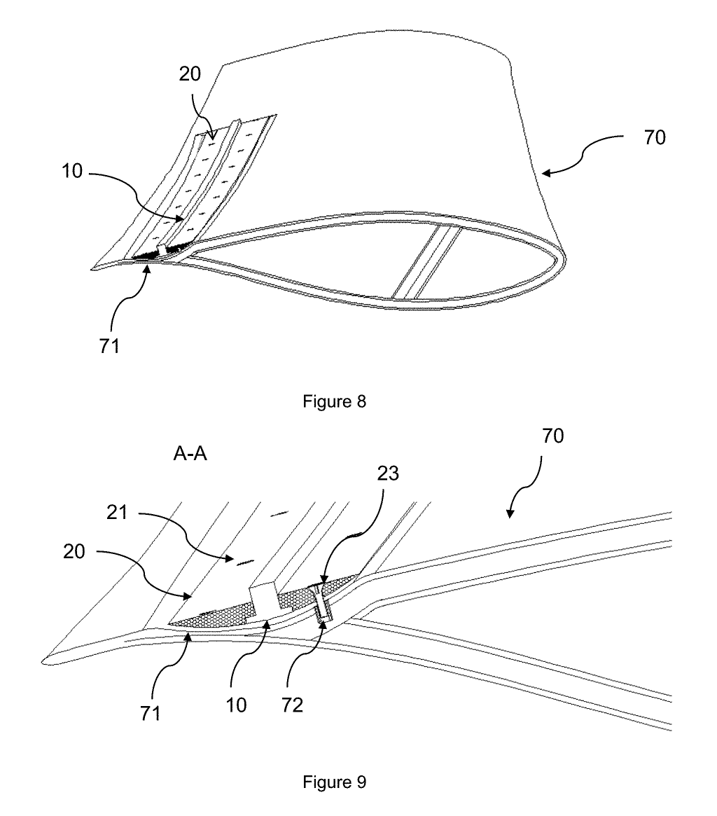

Referring to FIG. 2, use of this invention enables limiting aerodynamic forces of design, such as the lift force (FL) and the axial force (Fa) that blades are subject to during operation. This, because activating the inflatable seal or microtab (e.g., item 10 in FIG. 8 on blade 70) reduces the air flow at a certain height of the aerodynamic profile boundary layer and at a location close to the trailing edge of the aerodynamic profile. Furthermore, its activation results in no relevant change of the drag force (FD). It is worth mentioning it is relatively small in size and has low energy consumption.

Referring to FIGS. 3 and 4, the inflatable seal or microtab (10) is a flexible seal with a specific elongated shape. At its cross-section there is a wide rigid base (10a) with two projections (10b) not limited as to the shape, which may be square or rectangular, just to mention a few; and an upper part (10c) with two positions; retracted (with no air), whose height (a) enables being flush with the surface of the blade (70) and extracted (with air) which is activated by an electro-pneumatic valve (35, FIG. 12) and whose height (b) is what allows limiting the aerodynamic forces, because it reduces air flow at a height of the boundary layer of the aerodynamic profile. The inflatable seal or microtab (10) is hollow on the inside and allows being inflated to a required specific dimension; for which purpose it incorporates at least one pneumatic connection (10d) by means of which compressed air is supplied from the pneumatic feed system (30, FIG. 12).

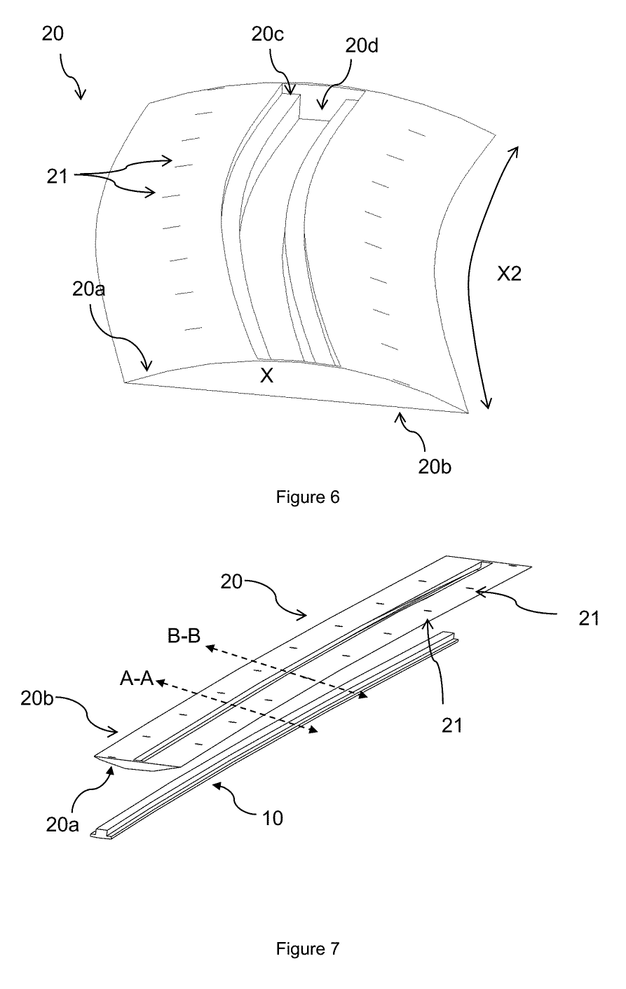

Referring to FIGS. 5 and 6, rigid cover (20) has a rounded convex shape at the underside (20a) which accurately assembles into the external cavity of the suction surface (71) of blade (70) along its entire shape and at the upper face (20b) it flattens, following the blade profile. In a cross-section (FIG. 6) there is a wide groove (20c) on the side of the underside (20a) and another groove (20d) crosses the thickness (X) of the rigid cover (20); both grooves (20c) and (20d) have a length (X2) along the rigid cover (20). The upper face (20b) has diameter (D) holes (21) that completely cross up to the underside (20a) and function to secure the rigid cover (20) to the blade (70).

The pneumatic activation system (30, FIG. 12) is integrated by pneumatic hoses (31), air inlets (32), a rotary seal (33), a quick release valve (34), an electro pneumatic valve (35), an air tank (36) and a progressive start unit (37).

Referring to FIGS. 4 and 5, the inflatable seal or microtab (10) is assembled onto the rigid cover (20). It is introduced from the underside (20a), in a way such that the upper portion (10c) of the inflatable seal or microtab (10) passes through the groove (20d) under pressure and the wide rigid base (10a) assembles to the wide groove (20c), in such way that the microtab (10) is secured and its position is guaranteed within the rigid cover (20). This way, both projections (10b) make it impossible for the inflatable seal or microtab (10) to fully pass through the groove (20d, FIG. 6) and secures the position of the inflatable seal or microtab (10) while in operation. Additionally, given that it is a flexible seal, it conforms under pressure to the groove (20d) and to the wide groove (20c) of the rigid cover (20), thus preventing insects, dirt and moisture from invading the junction between the inflatable seal or microtab (10) and the rigid cover (20). By using the configuration described of the inflatable seal or microtab (10) and the rigid cover (20), clogging is prevented while in field operation, because no moving parts are used as mechanical or electromechanical actuators and the contamination that could enter into the blade (70) is minimized.

Referring to FIGS. 8 and 9, the blade (70) has a cavity external to the suction surface (71), which is formed from the manufacture of the blade (70) shells in composite material molds. The cavity external to the suction surface (71) of the blade (70) incorporates the inserts (72) which, like the outer cavity, the pneumatic hoses (31, FIG. 11) and the air inlets (32, FIG. 11) are placed from the manufacture of the profile of the blade 70, which does not affect the aerodynamic shape of the blade, the cost of manufacture or its mechanical resistance, due to the fact that cuts are not made in the composite material, but a cavity with continuity of the fibers of the composite material. Similarly, pneumatic hoses (31) and air inlets (32) are placed inside the blade (70) from the time of blade manufacture; by which a closed body is formed, with no perforations or damages to the composite fibers of the blade; and with such minimum elements embedded inside the blade (70) the internal intervention of the blade (70) is minimized, as well as the risk of dirt entering and affecting in any way.

Referring to FIGS. 7 and 9, holes (21) of a predetermined diameter fully pass from the upper face (20b) to the lower face (20a), as shown in cross-section A-A; in order to allow fasteners (23) to be placed to secure the rigid cover (20) and the inflatable seal or microtab (10) onto the cavity external to the suction surface (71) of the blade (70). Fasteners (23) are fixed onto the cavity external to the suction surface (71) of the blade (70) by inserts (72) that allow a high degree of safety without damaging or compromising the structural strength of the blade (70).

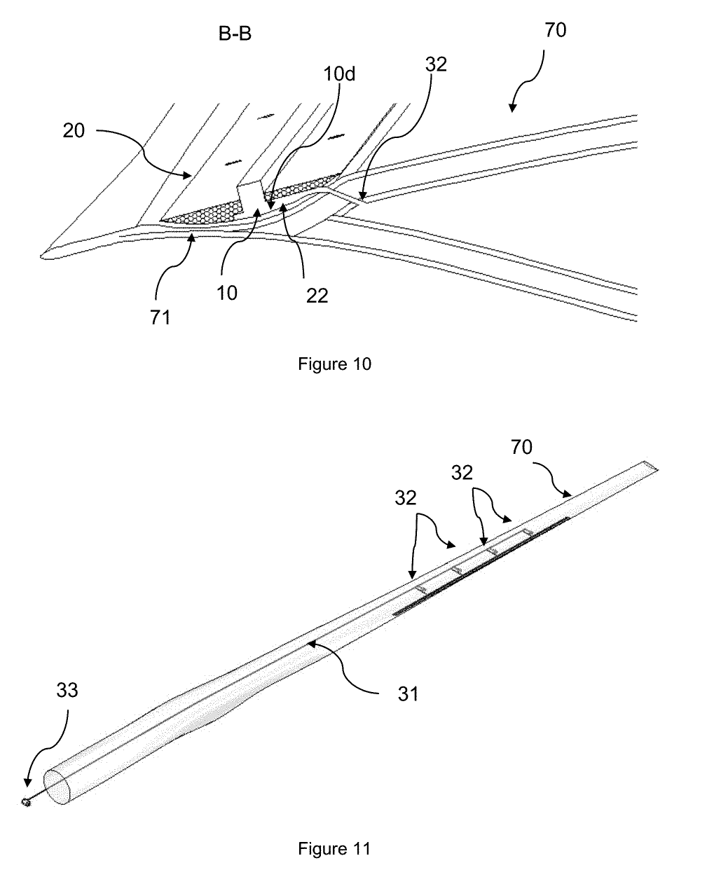

Scheduled maintenance to the pneumatic accessory to limit aerodynamic forces on the horizontal axis of wind turbine blades is possible in a simple way, since it is only necessary to withdraw fasteners (23) and disconnect the pneumatic connections (10d, FIGS. 3 and 10) of air intakes (32), thus preventing difficulty in manipulating the elements inside the blade (70), where access is difficult. So, for better performance, it is provided that blade manufacture forms a closed body with no perforations or damage to the composite material of blade. Thus, the rigid cover (20) is removed together with the inflatable seal or microtab (10) and maintenance may be provided at a less risky place, thus preventing assembly and disassembly maintenance that imply longer times at high elevations and not having to manipulate any element inside the blade (70).

The rigid cover (20) has at least one hole (22) that fully crosses from the groove (20d) to the underside (20a), as shown in cross-section B-B (FIGS. 6 and 7). This hole allows the pneumatic connection (10d) of the inflatable seal or microtab (10) to switch by a quick connection to the air inlets (32) of the pneumatic power supply system (30) (FIGS. 11 and 12). Air inlets (32) and pneumatic hose (31) are located embedded in the inside of the blade (70) (FIGS. 7 and 10).

The three blades (70, FIG. 1) typically incorporated by horizontal axis wind turbines (50) have a rigid cover (20, FIGS. 5-7) and an inflatable seal or microtab (10), thus their activation is performed simultaneously. Each blade (70) incorporates inside at least one pneumatic hose (31) and one air inlet (32) (FIG. 11) which supply compressed air to the inflatable seal or microtab (10) by at least one pneumatic connection (10d, FIG. 10).

Referring to FIG. 12, progressive start unit (37) allows cleaning the incoming compressed air stored in the air reservoir (36). This reservoir supplies compressed air upon demand; the electro-pneumatic valve (35) commanded by a control system (not shown) is activated to allow the passage of compressed air to in turn activate the inflatable seal or microtab (10) corresponding to each blade (70). A quick exhaust valve (34) is provided to facilitate exhaustion of compressed air and to increase the deflation rate of the inflatable seal or microtab (10). Thus, timely activation is applied from changes in wind speed: then the rotary seal (33) drives compressed air from the rotor (80, FIG. 1) to the blade (70) and is connected by means of a pneumatic hose (31) and in turn connects to at least one air inlet (32) which last, when required, activates the inflatable seal or microtab (10).

Use of an inflatable seal or microtab (10) has been studied in Computational Fluid Dynamics (CFD) and in wind tunnel for various aerodynamic profiles. The study was conducted through a composite central design, with three factors related to the inflatable seal or microtab (10) on the suction surface(s) of an aerodynamic profile (1), to limit aerodynamic forces: height, thickness and position regarding the cord (c) of an aerodynamic profile (1); and three response variables relating to the aerodynamic profile (1) of the blade (70): Lift coefficient L_{C}, drag coefficient D_{C} and aerodynamic performance C_{L}/C_{D}. Where L_{C} is the influence factor on the holding force (FL), through the aerodynamic equation (A):

$$FL = \frac{1}{2} ρ {V}_{rel}^{2} c {C}_{L} \qquad ( A )$$

Where:

ρ, is the density of the wind

Vᵣₑₗ is wind speed

c, is the aerodynamic profile cord

L_{C} is the aerodynamic lift coefficient

For the drag force, DF, through the aerodynamic equation (B):

$$FD = \frac{1}{2} ρ {V}_{rel}^{2} c {C}_{D} \qquad ( B )$$

For rotor axial force, Fₐ, through the aerodynamic equation (C):

Fₐ=L cos Ø+DsenØ (C)

Where:

φ, is the relative angle formed between the wind speed vector Vᵣₑₗ, and the profile cord c, (FIG. 2).

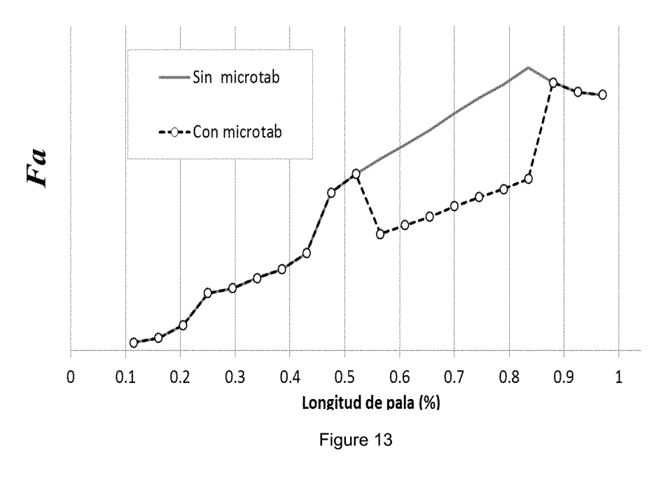

Results show optimum execution in aerodynamic performance, defined as the quotient between lift coefficient and drag coefficient LC/DC, for a 2% microtab height, 0.35% microtab thickness and 85% microtab position, all percentages stated as a function of cord (c) of an aerodynamic profile (1). Under nominal turbine operating conditions and in a steady condition, axial force reduction (Fa) can be estimated by the Blade Element Momentum method (BEM). FIG. 13 shows an example of axial force reduction ranging 20%, by using the inflatable seal or microtab (10) in the range of 55% to 85% of the radial length of the blade.

Particular wind speeds are taken into account in horizontal axis wind turbine (40) design. However, due to the random nature of wind behavior in certain areas, wind may exceed the speeds for which turbines were designed; so operation is not appropriate at wind speed conditions greater than the design speed, which can damage rotor (50) blades (70), the internal gondola components (60) and even the support or pole (80).

At times where design wind speed parameters have been exceeded, the pneumatic accessory to limit aerodynamic forces in horizontal axis wind turbine blades (2) is activated, thereby the flow of air is reduced at a height of the aerodynamic profile limit layer and consequently the axial force (Fa) is limited, which as shown in the aerodynamic equations (A), (B) and (C), varies directly proportional to the wind speed Vᵣₑₗ.

A control system (not shown) sequentially activates the progressive start unit (37) which is in charge of cleaning the incoming compressed air stored in the air reservoir (36). This reservoir subsequently supplies compressed air upon demand and the electro-pneumatic valve (35) is activated to allow passage of compressed air into the rotary seal (33) which enables passage of compressed inflatable seal air from the rotor (80) to the blade (70). This rotary seal (33) is connected by a pneumatic hose (31) and this one in turn connects with at least one air inlet (32) that activates the inflatable seal or microtab (10) for the time necessary to mostly limit the axial force (Fa). By the time it is no longer necessary to maintain the inflatable seal or microtab (10) active, compressed air stops being supplied and the quick exhaust valve (34) facilitates the compressed air exhaustion to increase the deflation rate of the inflatable seal or microtab (10), thus resulting in timely activation/deactivation to changes in wind speed.

Referring to FIG. 13, through use of this invention, it is possible to limit the aerodynamic design forces that blades are subject to while in operation, axial force reduction (Fa) in the order of 20%; by using the inflatable seal or microtab (10) in the zone of 55% to 85% of the radial length of blade, thereby the lifespan of turbine components may be increased due to a reduction in the magnitude of the lifting force and the axial force while wind turbine is operating.

It also allows using longer blades to capture greater wind energy, by using power generation components designed for a smaller rotor diameter. Thus, the annual production of energy from turbines acreages by increasing rotor diameter without changing air turbine components, Rotor diameter increase implies using longer blades to capture greater amount of kinetic energy from the same wind speed, i.e., the area for capturing energy from the wind is greater, which increases energy capture but using smaller forces than the ones developed without the accessory.

### OTHER EMBODIMENTS

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

### REFERENCES CITED

All publications, patents, patent applications and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present invention.

What is claimed is:

1. A pneumatic device for limiting aerodynamic forces on the horizontal axis of a wind turbine blade, the device comprising the wind turbine blade integrated with an inflatable seal or microtab, a rigid cover, and a pneumatic feed system,
wherein the inflatable seal or microtab is assembled onto the rigid cover, both of which are mounted on the blade.

2. The pneumatic accessory of claim 1, wherein:
the inflatable seal or microtab is a flexible seal having a predetermined elongated shape having at its cross-section a wide rigid base with two projections;
and an upper part having positions of variable height enabling the inflatable seal or microtab to be flush with the surface of the blade, and extracted, the variable height activated by an electro-pneumatic valve.

3. The pneumatic accessory of claim 2, wherein the inflatable seal or microtab is hollow on the inside and can be inflated to a predetermined dimension.

4. The pneumatic accessory of claim 1, wherein the rigid cover comprises a rounded convex shape at the underside which assembles into the external cavity of a suction surface of the blade along its entire shape, and at an upper face the shape flattens following the blade profile;

5. The pneumatic accessory of claim 4, wherein in a cross-section there is provided a first wide groove on the side of the underside, and a second groove crosses the thickness of the rigid cover.

6. The pneumatic accessory of claim 5, wherein the upper face has holes having a predetermined diameter that completely cross up to the underside and function to secure the rigid cover to the blade, and wherein at least one hole fully crosses from the first or second groove to the blade underside.

7. The pneumatic accessory of claim 1, comprising a pneumatic feed system integrated by pneumatic hoses, air inlets, a rotary seal, a quick exhaust valve, an electro pneumatic valve, an air reservoir, and a progressive start unit.

8. The pneumatic accessory of claim 1, wherein the inflatable seal or microtab is assembled onto the rigid cover introduced from the underside such that the upper portion of the inflatable seal or microtab passes through a groove under pressure and the wide rigid base assembles to a wide groove such that the microtab is secured, whereby both projections allow for the inflatable seal or microtab to fully pass through the groove and secure the position of the inflatable seal or microtab while in operation, and the flexible seal adjusts to the groove under pressure and to the wide groove of the rigid cover.

9. The pneumatic accessory of claim 1, wherein the blade comprises a cavity external to the suction surface which incorporates inserts, pneumatic hoses, and air inlets which are located inside the blade.

10. The pneumatic accessory of claim 6, wherein the holes that fully pass from the upper face to the underside allow fasteners to be placed to fix the rigid cover and the inflatable seal or microtab in the cavity external to the suction surface of the blade.

11. The pneumatic accessory of claim 10, wherein a hole that enables the pneumatic connection of the inflatable seal or microtab to switch by a quick connection to the air inlets of the pneumatic power supply system, and air inlets and a pneumatic hose are located in the blade.

12. The pneumatic accessory of claim 1, wherein the inflatable seal or microtab has a 2% height, 0.35% thickness and a position in 85%, all percentages of which are stated as a function of the cord of an aerodynamic profile.
